(19) United States
(12) Patent Application Publication
(10) Pub. No.: US 2006/0294334 A1
(43) Pub. Date: Dec. 28, 2006

(54) Statement regarding federally sponsored-research or development

(75) Inventors: Joefon Jann, Ossining, NY (US); Ramanjaneya Sarma Burugula, Peekskill, NY (US); Pratap Chandra Pattnaik, Ossining, NY (US)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 11/165,318

(22) Filed: Jun. 23, 2005

(51) Int. Cl. G06F 12/00

(52) U.S. Cl. 711/170; 711/207

(57) ABSTRACT

A method of determining and using the optimal page size in the execution of an application wherein the number of virtual to real address caching mechanism misses per unit time is calculated for available page sizes and wherein the optimal page size is determined based on the determined number of mechanism misses. In a more specific aspect of this invention, mechanism misses per unit time are calculated for only those applications which are more likely to consume computer system resources. In yet another more specific aspect of this invention, the mechanism misses for a selected application are determined for each of a number of memory address regions.

### CROSS-REFERENCE TO RELATED APPLICATIONS

Not Applicable

### STATEMENT REGARDING FEDERALLY SPONSORED-RESEARCH OR DEVELOPMENT

Not Applicable

### TECHNICAL FIELD

This invention is related to a method and apparatus for dynamically determining the optimal page size to use for an application running in a computer system.

### BACKGROUND OF THE INVENTION

Referring to FIG. 1, there is shown a typical data processing system 10 comprising a central processing unit (CPU) 12 which occasionally requires accesses to data elements stored in the physical memory 14. The CPU 12 specifies particular elements using virtual addresses which are mapped to real addresses by the Dynamic Address Translation (DAT) unit 16. To minimize the overhead for maintaining a description of the current mapping, contiguous blocks of virtual memory are mapped to contiguous blocks of real memory. The size of the block is called a “page”. A page typically contains one or more records and, for many computers, comprises 4096 bytes, where a byte is the number of bits required to represent a single character (usually 8 bits). However, in the description of the present invention, the term “page” may be any arbitrary block of data. To improve performance, mapping information for recently translated pages is maintained in the DAT unit with a Translation Look-aside Buffer (TLB) 18. While, for illustrative purposes, the CPU 12 is depicted as being separate from the dynamic address translation mechanism, both these items may be on the same chip.

With the advent of multiple page size support in most modem operating systems, applications can significantly benefit by selecting an appropriate page size to use to attain the best performance. On a system that supports two page sizes, for example 4 KB and 64 KB, applications which access small dispersed chunks of memory (from a program address' perspective) are better off using the smaller page size of 4 KB. The trade-off in page size selection is typically increased memory fragmentation and longer page-in and page-out delays for larger page sizes versus increased TLB (Translation Look-aside Buffer) misses with decreased fragmentation and shorter page-in and page-out delays for smaller page sizes.

A Translation Look-aside Buffer (TLB) is a hardware apparatus with which a processor can efficiently translate the virtual/effective addresses used by the applications to the real/physical addresses used by the memory controller/coherence controller, etc. The TLB is organized as a list of entries, where each entry maps a contiguous range of virtual addresses (e.g. one page) to a contiguous range of physical addresses of the same size. The size of a TLB (number of entries) is limited by the amount of time it takes to associatively search the TLB entries.

Whenever there is a TLB miss (i.e. a TLB entry cannot be found for the given virtual address), the processor looks up the virtual-to-real address translation in the page table. Page table lookup is a much more time consuming operation than a TLB lookup. So, from the application performance's point of view, and also from the overall system throughput's point of view, it is best to have as few TLB misses as possible.

Since increasing the page size of each TLB entry amounts to increasing the amount of memory covered by the TLB at any point in time (“TLB reach”), one might think that one way of reducing the number of TLB misses is to increase the size of the address range (page size) referred to by each TLB entry. However, increasing page size may not necessarily result in reduction in the number of TLE misses, which can vary for each application depending on the memory access behavior of that application. For example, if an application's memory access patterns are highly dispersed, then increasing the page size would not result in any reduction in TLB misses; moreover, increasing page size may cause memory fragmentation, thereby resulting in lower memory utilization for the OS.

Currently, the application programmer or the system administrator has to know the memory access patterns of the application and instruct the operating system to use the best page size for each application. This becomes even more complex because users often want to run their applications on different platforms, but different platforms support different page sizes. Hence, an application programmer has to know which platforms the application is going to run on, which page sizes are supported on those platforms, and what is the best page size to use on each of those platforms. On a given platform, requiring the system administrator to select the right page size for each application introduces an even bigger problem of the sysadmin having to know each application's characteristics. It also involves much manual work, and hence increases the probably of errors.

One attempt to relieve the programmer of the burden of having to adjust page size is a method known as “preemptive reservation”, where the Virtual Memory Manager (VMM) reserves large page sizes, but “takes back” the unused reserved memory if there is a demand for real memory. While “preemptive reservation” is effective against fragmentation, it is not effective against TLB misses. “Preemptive reservation” is described in the following paper: Juan Navarro, Rice University and Universidad Catolica de Chile; Sitaram Iyer, Peter Druschel, and Alan Cox, Rice University; Practical, Transparent Operating System Support for Superpages; Fifth Symposium on Operating Systems Design and Implementation, December 2002.

There is therefore a need for automatic and dynamic changing to an optimum page size determined as a result of running an application.

### OBJECTS OF THE INVENTION

It is, therefore, an object of this invention to autonomically determine and dynamically set the page size of an application to an optimal value by tracking the number of virtual to real address translation mechanism misses (for example, TLB (Translation Look-aside Buffer misses) for each page size per unit of time incurred during the execution of that application on a given platform (i.e. hardware and operating system combination).

It is another object of this invention to eliminate the need for the system administrator to manually specify the optimal page size for an application.

It is another object of this invention to eliminate the need for the application programmer and/or system administrator to know the correct page size to use for an application's memory accesses, and the need to know the different page sizes available on a given platform.

### SUMMARY OF THE INVENTION

This invention uses a mechanism to keep track of the number of virtual to real address translation caching mechanism misses, such as TLB misses, on a per-process basis, associates an application with a set of processes, determines the optimum page size for the application based on the miss counts for the application's processes, and optionally, dynamically sets the optimal page-size for the running application. This invention can also be used to discover different optimal page sizes for different memory regions in the process.

This invention provides a mechanism to determine the optimal page size for an application by monitoring the TLB misses for different page sizes.

This invention provides a mechanism to maintain the list of frequently used applications whose TLB misses are worth tracking, to identify the list of processes of each application, to enable/disableTLB-miss-tracking for each of the processes, to maintain the TLB misses on a per-process basis, and to consolidate the per-process TLB misses into per-application TLB misses, and finally to determine whether the page size of each application should be changed based on its TLB misses.

With this invention, the application programmer and/or system administrator is relieved of the need to know the correct page size to use for the application's memory accesses, and the need to know of the different page sizes available on a given platform. This invention also eliminates the need for the system administrator to manually specify the optimal page size for the applications.

Most computer platforms already have a mechanism to accumulate the TLB miss counts. This invention uses such a mechanism to keep track of the number of TLB misses on a per-process basis.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings.

FIG. 1 shows a portion typical data processing system with a processor, Dynamic Address Translation Table (DAT), Translation Look-aside Buffer (TLB), and memory for implementing one embodiment of the present invention.

FIG. 2 is a flow diagram graphically illustrating a method of maintaining the Application State Table that is used for implementing one embodiment of the present invention.

FIG. 3 is a flow diagram graphically illustrating a method of maintaining the Application Page Size Data Table that is used for implementing one embodiment of the present invention.

FIG. 4 graphically illustrates the Application Page Size Data Table that is used for implementing one embodiment of the present invention.

FIG. 5 graphically illustrates the Application State Table that is used for implementing one embodiment of the present invention.

FIG. 6 graphically illustrates the Application Processor List that is used for implementing one embodiment of the present invention.

FIG. 7 graphically illustrates how the Translation Look Aside Buffer (TLB) miss counter is maintained for one embodiment of the present invention.

FIG. 8 is a high level block diagram showing an information processing system useful for implementing one embodiment of the present invention

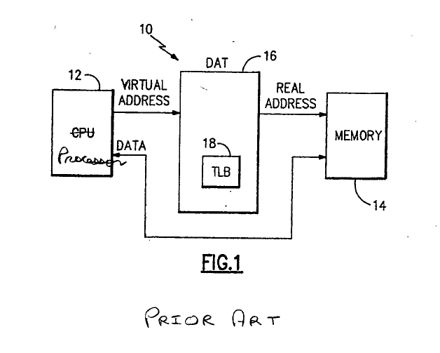

### DETAILED DESCRIPTION OF THE INVENTION

This invention provides a mechanism to determine the optimal page size for an application by monitoring the TLB misses for different page sizes. This detailed description describes:

1. A mechanism to maintain the list of frequently used applications whose TLB misses are worth tracking.

2. A mechanism to identify the list of processes of each application, and to enable/disable TLB-miss-tracking for each process.

3. A mechanism to maintain the TLB misses on a per-process basis.

4. A mechanism to consolidate the per-process TLB misses into per-application TLB misses, and to determine whether the page size of each application should be changed.

Although it is assumed for the purposes of illustration that one single page size is used for all of the application's data, the methods described in this invention can be used even when different address regions of the application use different page sizes. The hardware could provide a mechanism to obtain the TLB miss data for each region while the OS provides mechanisms to get and set the page size value for each address region.

The current invention is not limited to TLB-based systems; it is also applicable to any virtual-to-real address translation caching mechanisms.

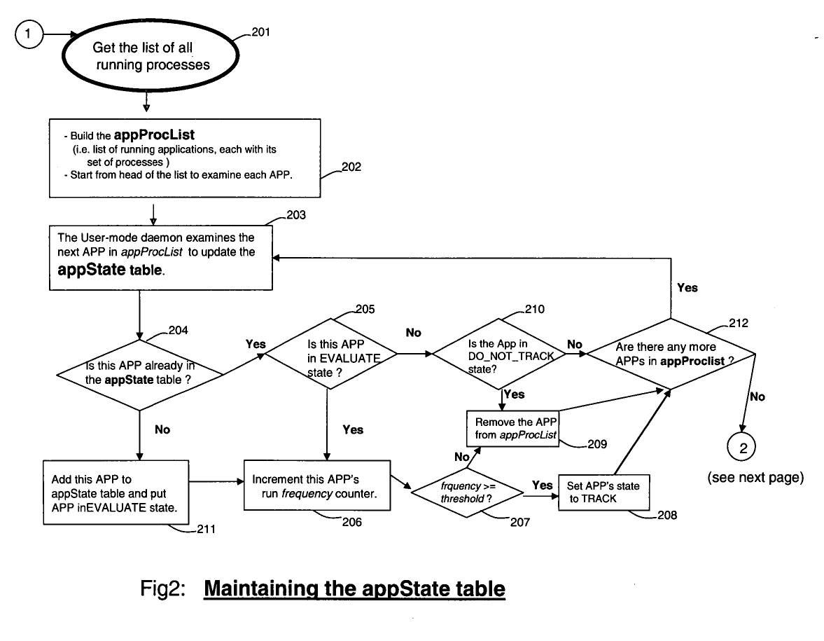

1. A mechanism to maintain the list of frequently used applications whose TLB misses are worth tracking. See FIGS. 2, 4, and 6.

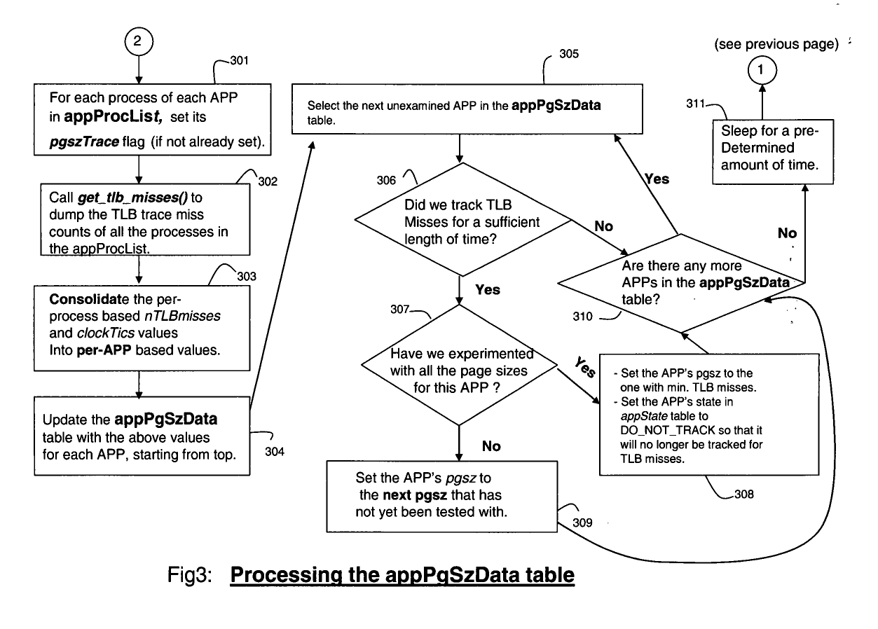

Referring to FIG. 2, the first step is to identify applications whose TLB misses are worth tracking. The idea is that the server operating systems typically run a small number of frequently used applications which utilize operating system (OS) resources heavily and run many other infrequently used applications which utilize OS resources sparingly. Since tracking TLB misses adds overhead, one should track the TLB misses for only those applications that can provide significant benefits from using a higher page size. To identify these applications, a user mode daemon periodically polls the OS for the list of applications and processes that are currently running as shown in 201 of FIG. 2. Then, a list of processes belonging to each application is identified 202 and maintained in a Application Process List 600 of FIG. 6. Then, in step 203 of FIG. 2, each application in the List 600 is selected, and examined as described in steps 204 to 210 to maintain the Application State Table 400 of FIG. 4. In step 204 of FIG. 2, it is determined if an application is listed in the Application State Table 400. If the application is listed then the state of the application is checked. If the application is in the “Evaluate” state (205), then in step 206, the application's run frequency counter is incremented. If the counter exceeds a threshold (207), then the application state is set to “Track” (208). On the other hand, if the frequency counter is below the threshold (207), the application is removed (209) from the Application Process List. However, if the listed application was originally found to be in the “Do Not Track” state 210, then the application is removed from list 600. If in step 204, the application was not found in the Application State Table 400, then the application is added to the Table 400 as shown in step 211 of FIG. 2. This added application is initialized to the “Evaluate” state, and its frequency counter is initialized to 0. Then, in step 206, the added application's frequency counter is incremented to determine its final state. If there are any additional applications in the List 600 to be examined, then the state of the application is updated by starting at step 203. If there are no more applications to be examined (212), then the Application Page Size Table is maintained as shown in FIG. 3.

An alternative mechanism to identify the frequently used applications that are worth tracking is to use the Operating system provided accounting tools. Operating systems typically come with software tools that enable system administrators to keep track of which applications are running on the system, which users are logged on to the system and for how long, etc. These tools are referred to as “accounting tools” since they are used to track the usage of the system and charge the customers based on the usage.

Referring now to FIG. 3, the Application Page Size Table is maintained by first setting a pgszTrace flag (See below.) for each process of each application (301) in the Application Process List 600. Then, in step 302, the user daemon reads all the TLB miss counters and corresponding CPU times for all the processes by invoking a system call get_tlb_misses as described below.

| | | |
|---|---|---|
| get_tlb_misses ( pidTlbMisses_t | *buf, | int *n_entries). |

This system call reads all the per-process data structures in the kernel and stores the TLBmisses and clockTics values into the buf provided.

The type pidTlbMisses_t is defined as follows:

| typedef struct | |
|---|---|
| { pid_t pid; | /* Process identification number */ |

| | |
|---|---|
| long nTLBmisses; | /* TLB miss counter */ |

| | |
|---|---|
| time_t clockTics; | /* CPU time used by the process */ |

} pidTlbMisses_t;

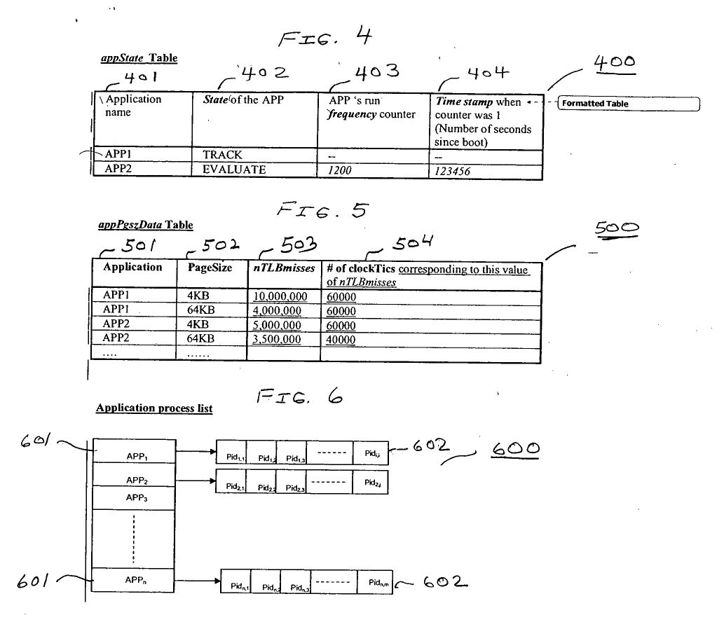

In step 303 the TLB miss counters and corresponding CPU times for each application are calculated by adding all the TLB miss counters of all the processes belonging to each application. Note, that instead of simply adding TLB miss counter values, one could also add weighted TLB miss counter values. In step 304, the Application Page Size Table 500 of FIG. 5 is updated with the calculated TLB miss counter values inserted in column 503 and corresponding CPU times inserted in column 504. In step 305 each application in the Application Page Size Table 500 is examined as described below. In step 306 the CPU time is checked to determine if more tracking is needed by comparing the CPU time with a minimum running time threshold value. If the running time is below the threshold, then the next unexamined application ( That is, the application was not checked for a sufficient CPU time period or to determine if all page sizes were tried as described in steps 306-307 of FIG. 3) in the Table 500 is selected. If, on the other hand, the running time is above the threshold, then (307) the Application Page Size Table 500 is checked to see if there are any more page sizes to try for the current application being processed. If there are no more page sizes to examine, then as indicated in 308, the Application Page Size Table 500 is examined to determine which page sized yielded the minimum TLB misses per unit time as indicated in the TLB miss counters. In addition, in step 308 the Application State Table 400 of FIG. 4 is updated to put the current application in the “Do Not Track” state; so that it will no longer be tracked for TLB misses. On the other hand, in step 307, if it is found that there are some page sizes that still need to be tried, then the application page size is set to the next untried page size as indicated in step 309. After steps 308 and 309, the Application Page Size Table is checked to see if there are any more applications that need to be examined as shown in 310. If there are any remaining applications to be examined, then next unexamined application in the Application Page Size Data Table 500 is selected in step 305 and examined in steps 306 to 309. If, however, all the applications in the Table 500 have been examined, then the user mode daemon sleeps for a period of time (311) and proceeds to step 201 of FIG. 2 after waking up.

Tables 400, 500, and List 600 are described below.

Shown in FIG. 4 is an appState table (Application State Table) 400 that is used to keep track of the run frequency counters for each application listed therein. The first column 401 lists the applications in the table, and the corresponding state of each application is listed in column 402. Columns 403 and 404 include the frequency counter values and the time stamps respectively. The states are described immediately below.

TRACK→the application is already marked for TLB miss tracking;

EVALUATE→the application is being evaluated to determine whether its TLB misses should be traced;

DO_NOT_TRACK→the application should not be tracked for TLB misses.

FIG. 4, for example, shows two applications (See 402.), where the first application (APP1) is in the TRACK state and the second application (APP2) is in the EVALUATE state with the frequency counter at 1200 (See 403.). The frequency counter 403 measures the number of times the application is found to be running since the time stamp 404. The time stamp 404 is an indication of when the application was found to be running for the first time, which is measured by the number of seconds that elapsed since the system was booted.

Once an application is identified as a candidate whose TLB miss rate should be tracked, it will be added to an appPgSzData table as shown in FIG. 5. This table (500) will be used to maintain information about the TLB misses for different page sizes for an application (See 501.). For example, in FIG. 5, there are four entries, each indicating the number of TLB misses (See 503.) and the corresponding number of clock ticks (504) for a specific page size (502) for a specific application (See 501.).

FIG. 6 shows how the Application Process List 600 is maintained. Each application 601 has a link to the list of all the processes 602 that belong to it. This list is dynamically expanded and shrunk as new applications and processes are created in the operating system (OS), and old ones are terminated.

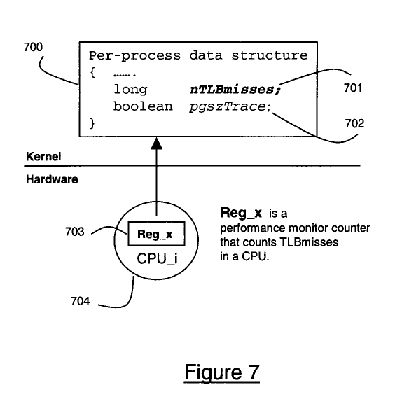

FIG. 7 shows how the TLB miss counter values are maintained inside the OS kernel with the help of the processor and its register. For each process, a value, nTLBmisses (701), is maintained in the kernel's per-process data structure 700 to keep track of the number of TLB misses. This field will be updated by all the threads belonging to the process. Whenever there is a context switch on a CPU 704 (i.e. change of thread—from old thread to new thread—running on a CPU), the dispatcher takes the following actions:
a) If the old thread's process has the pgszTraceflag (702) set (see below), read the CPU register (703) that maintains the number of TLB misses, and atomically add the value to the nTLBmisses field of the old process.
b) If the new thread's process has the pgszTrace flag (702) set, reset the CPU register (703) that maintains the number of TLB misses.

Since maintaining the TLB misses for every process adds overhead to the system, we want to track the TLB misses for only those applications which can significantly benefit themselves and other users of the OS by changing their page size. So, we will also maintain a flag in the kernel, pgsztrace, (702) in each process' kernel data structure to indicate that this process' TLB misses should be tracked. The following syscall provides the interface to set/reset this flag for each process.

| | |
|---|---|
| int trace_tlb_misses(pid_t pid, int flag) | /* where flag can |
| | have value of |
| | TRACE_ON or |
| | TRACE_OFF */ |

FIG. 8 is a high level block diagram showing an information processing system useful for implementing one embodiment of the present invention. The computer system includes one or more processors, such as processor 12. The processor 12 is connected to a communication infrastructure 802 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 708 that forwards graphics, text, and other data from the communication infrastructure 802 (or from a frame buffer not shown) for display on the display unit 710. The computer system also includes a main memory 14, preferably random access memory (RAM), and may also include a secondary memory 712. The secondary memory 712 may include, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a manner well known to those having ordinary skill in the art. Removable storage unit 718, represents a floppy disk, a compact disc, magnetic tape, optical disk, etc. which is read by and written to by removable storage drive 716. As will be appreciated, the removable storage unit 718 includes a computer readable medium having stored therein computer software and/or data.

In alternative embodiments, the secondary memory 712 may include other similar means for allowing computer programs or other instructions to be loaded into the computer system. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computer system.

The computer system may also include a communications interface 724. Communications interface 724 allows software and data to be transferred between the computer system and external devices. Examples of communications interface 724 may include a modem, a network interface (such as an Ethernet card), a communications port, a PCMCIA slot and card, etc. Software and data transferred via communications interface 724 are in the form of signals which may be, for example, electronic, electromagnetic, optical, or other signals capable of being received by communications interface 724. These signals are provided to communications interface 724 via a communications path (i.e., channel) 726. This channel 726 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 14 and secondary memory 712, removable storage drive 716, a hard disk installed in hard disk drive 714, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 14 and/or secondary memory 712. Computer programs may also be received via communications interface 724. Such computer programs, when executed, enable the computer system to perform the features of the present invention as discussed herein. In particular, the computer programs, when executed, enable the processor 12 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method of determining the optimal page size to be used in the execution of an application, said method comprising:
determining a number of virtual to real address translation caching mechanism misses per unit time for said application for at least one available page size of said application; and
determining said optimal page size based on said determined number of said mechanism misses.

2. A method as recited in claim 1, wherein the number of virtual to real address translation caching mechanism misses per unit time for said application are determined for a plurality of page sizes.

3. A method as recited in claim 1, wherein said optimal page size is determined by comparing the number of virtual to real address translation caching mechanism misses per unit time for said application for each of said available page sizes, and by selecting the page size which produced a minimum number of virtual to real address translation caching mechanism misses per unit time.

4. A method as recited in claim 1, wherein said virtual to real address translation caching mechanisms comprises any one of the following; a translation look aside buffer table, and an effective to real address translation table.

5. A method of using optimal page sizes in a computer system, said method comprising:
selecting a set of applications;
identifying a set of processes for each of said applications;
for each of said selected applications, determining the number of translation look aside buffer misses per unit time for said corresponding identified processes for at least one available page size of said page sizes; and
determining an optimal page size of said page sizes for each of said selected applications based on said determined number of said translation look aside buffer misses; and
automatically setting a corresponding said optimal page size for each of said selected applications when each application is running.

6. A method as recited in claim 5, wherein said applications are selected on the basis of frequency of use.

7. A method as recited in claim 5, wherein said number of translation look aside buffer misses per unit time for said selected applications are determined by: enabling TLB-miss-tracking for each of said corresponding identified processes to maintain the TLB misses on a per-process basis, and consolidating the per-process TLB misses into per-application TLB misses.

8. A method of determining optimal page sizes to be used by an application using a plurality of address regions, said method comprising:
determining a number of virtual to real address translation caching mechanism misses per unit time for each of a number of said address regions used by said application for at least one available page size; and
calculating a corresponding optimal page size for each of said number of address regions based on said determined number of said mechanism misses.

9. A computer program product comprising a computer useable medium including a computer readable program, wherein the computer readable program when executed on a computer causes the computer to:
determine the number of virtual to real address translation caching mechanism misses per unit time for said application for at least one available page size of said application; and
determine said optimal page size based on said determined number of said mechanism misses.
